(19) United States
(12) Patent Application Publication
(10) Pub. No.: US 2026/0047513 A1
(43) Pub. Date: Feb. 19, 2026

(54) SYSTEM AND METHOD FOR DETECTING AIR POCKETS WITHIN AN AGRICULTURAL FIELD

(71) Applicant: CNH Industrial America LLC, New Holland, PA (US)

(72) Inventors: Michael Pregesbauer, Traiskirchen (AT); Mario Rathmanner, Traiskirchen (AT); Michael Christopher Conboy, Chicago, IL (US)

(21) Appl. No.: 18/930,304

(22) Filed: Oct. 29, 2024

Related U.S. Application Data
(60) Provisional application No. 63/684,613, filed on Aug. 19, 2024.

(51) Int. Cl. A01C 7/20; A01B 79/00; A01C 5/06

(52) U.S. Cl. CPC A01C 7/20; A01B 79/005; A01C 5/068

(57) ABSTRACT

A system for detecting air pockets within a field includes a ground-engaging tool configured to engage the soil of the field during a seed planting operation. Additionally, the system includes a non-contact-based sensor configured to capture data indicative of the subsurface soil of the soil and a computing system communicatively coupled to the non-contact-based sensor. The computing system is configured to determine a property of the subsurface soil based on the data captured by the non-contact-based sensor. Additionally, the computing system is configured to determine when an air pocket is present between a seed planted within the subsurface soil and the subsurface soil based on the determined property of the subsurface soil.

### CROSS-REFERENCE TO RELATED APPLICATIONS

This application is based upon and claims the right of priority to U.S. Provisional Patent Application No. 63/684,613, filed on August 19, 2024, the disclosure of which is hereby incorporated by reference herein in its entirety for all purposes.

### FIELD OF THE INVENTION

The present disclosure generally relates to systems and methods for detecting characteristics of an agricultural field and, more particularly, to systems and methods for detecting air pockets within an agricultural field.

### BACKGROUND OF THE INVENTION

Modern farming practices strive to increase yields of agricultural fields. In this respect, seed-planting implements are towed behind a tractor or other work vehicle to disperse seed throughout a field. For example, seed-planting implements typically include one or more furrow-forming tools or openers that excavate a furrow or trench in the soil. One or more dispensing devices of the seed-planting implements may, in turn, deposit the seeds into the furrow(s). After deposition of the seeds, a furrow-closing assembly may close the furrow in the soil, such as by pushing the excavated soil into the furrow.

When performing seed-planting operations, it is generally desirable to firm or pack the soil once the seed has been covered to promote favorable seed-to-soil contact. As such, press wheels, closing disks, and/or other ground-engaging tools supported on the seed-planting implement are pulled across the soil surface to pack the soil. However, oftentimes air pockets are formed below the soil surface. Air pockets positioned between seeds and the soil can result in unfavorable seed-to-soil contact, which may result in an undesirable crop yield.

Accordingly, a system and method for detecting air pockets within a field would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a seed-planting implement. The seed-planting includes a row unit frame and a ground-engaging tool supported by the row unit frame and configured to engage soil of the field during a seed planting operation. Additionally, the seed-planting implement includes a non-contact-based sensor configured to capture data indicative of subsurface soil of the soil. Furthermore, the seed-planting implement includes a computing system communicatively coupled to the non-contact-based sensor. The computing system is configured to determine a property of the subsurface soil based on the data captured by the non-contact-based sensor. Moreover, the computing system is configured to determine when an air pocket is present between a seed planted within the subsurface soil and the subsurface soil based on the determined property of the subsurface soil. Furthermore, when determined that the air pocket is present, the computing system is configured to initiate a control action associated with adjusting a force applied to the ground-engaging tool.

In another aspect, the present subject matter is directed to a system for detecting air pockets within a field. The system includes a ground-engaging tool configured to engage soil of the field during a seed planting operation. Furthermore, the system includes a non-contact-based sensor configured to capture data indicative of subsurface soil of the soil. Additionally, the system includes a computing system communicatively coupled to the non-contact-based sensor. The computing system is configured to determine a property of the subsurface soil based on data captured by the non-contact-based sensor. Furthermore, the computing system is configured to determine when an air pocket is present between a seed planted within the subsurface soil and the subsurface soil based on the determined property of the subsurface soil.

In a further aspect, the present subject matter is directed to a method for detecting air pockets within a field as a seed-planting implement travels across the field. The seed-planting implement, in turn, includes a ground-engaging tool configured to engage soil of the field during a seed-planting operation. The method includes receiving, with a computing system, non-contact-based sensor data indicative of subsurface soil of the soil. Furthermore, the method includes determining, with the computing system, a property of the subsurface soil based on the received non-contact-based sensor data. Additionally, the method includes determining, with the computing system, when an air pocket is present between a seed planted within the subsurface soil and the subsurface soil based on the determined property of the subsurface soil. Moreover, the method includes initiating, with the computing system, a control action associated with adjusting a force applied to the ground-engaging tool when determined that the air pocket is present.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of one embodiment of a seed-planting implement in accordance with aspects of the present subject matter;

FIG. 2 illustrates a side view of one embodiment of a row unit of a seed-planting implement in accordance with aspects of the present subject matter;

FIG. 3 illustrates an example cross-sectional view of a portion of the soil within an agricultural field and an embodiment of a non-contact-based sensing device that may be used with a seed-planting implement in accordance with aspects of the present subject matter;

FIG. 4 illustrates an example cross-sectional view of a portion of the soil within an agricultural field in accordance with aspects of the present subject matter, particularly illustrating various subsurface soil layers with the portion of the soil;

FIG. 5 illustrates a schematic view of one embodiment of a system for detecting air pockets within a field in accordance with aspects of the present subject matter;

FIG. 6 illustrates a flow diagram providing a first embodiment of example control logic for detecting air pockets within a field in accordance with aspects of the present subject matter;

FIG. 7 illustrates a flow diagram providing a second embodiment of example control logic for detecting air pockets within a field in accordance with aspects of the present subject matter; and

FIG. 8 illustrates a flow diagram of one embodiment of a method for detecting air pockets within a field in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for detecting air pockets within an agricultural field. As will be described below, an agricultural field includes subsurface soil into which seeds are deposited and packed over with soil. Sometimes, air pockets positioned between deposited seeds and the surrounding soil form within the subsurface soil during or after the seeds have been packed over with soil. Air pockets are voids below the surface of the field, such as within the subsurface soil, and are generally large enough to contain one or more seeds. For example, the width of such air pockets may range from one centimeter wide to more than several inches wide. Such air pockets are generally undesirable as the lack of seed-to-soil contact often results in an undesirable crop yield.

In several embodiments, the disclosed system may be configured to determine when an air pocket is present between a seed planted within the subsurface soil and the subsurface soil. More specifically, the system may include a non-contact-based sensor configured to capture data indicative of movement of the subsurface soil. As such, a computing system may determine one or more properties, such as electrical properties, of the subsurface soil based on the data captured by the non-contact-based sensor. Thereafter, the computing system may determine when the air pocket is present between the seed planted within the subsurface soil and the subsurface soil based on the determined property of the subsurface soil. For example, in some embodiments, the computing system may compare the determined property to a predetermined property value range. When the determined property falls within the predetermined property value range, the computing system may determine that the air pocket is present.

Detecting the presence of air pockets between planted seeds and the surrounding soil based on a property of the subsurface soil generally improves seed-planting operations. More specifically, the properties, such as the electrical properties, of the packed subsurface soil are generally the same or approximately the same throughout the field. However, the properties of packed subsurface soil with air pockets positioned between seeds and surrounding soil are generally different than the properties of packed subsurface soil without air pockets. As such, determining the property(ies) of a subsurface soil layer allows for determination of the presence of air pockets between seeds planted within the subsurface soil and the subsurface soil. Thereafter, the tool(s) (e.g., press wheel(s), closing disk(s)) of a seed-planting implement may be controlled based on the presence of air pockets. For example, when the presence of one or more air pockets is determined, the force applied by the tool(s) to the ground surface may be increased to ensure that the tool(s) pack the soil closer to the seed and collapse the air pocket(s). Thus, the disclosed systems and methods generally allow for better seed-to-soil contact within the field, which improves the effectiveness of the seed planting operation and the subsequent agricultural performance of the field.

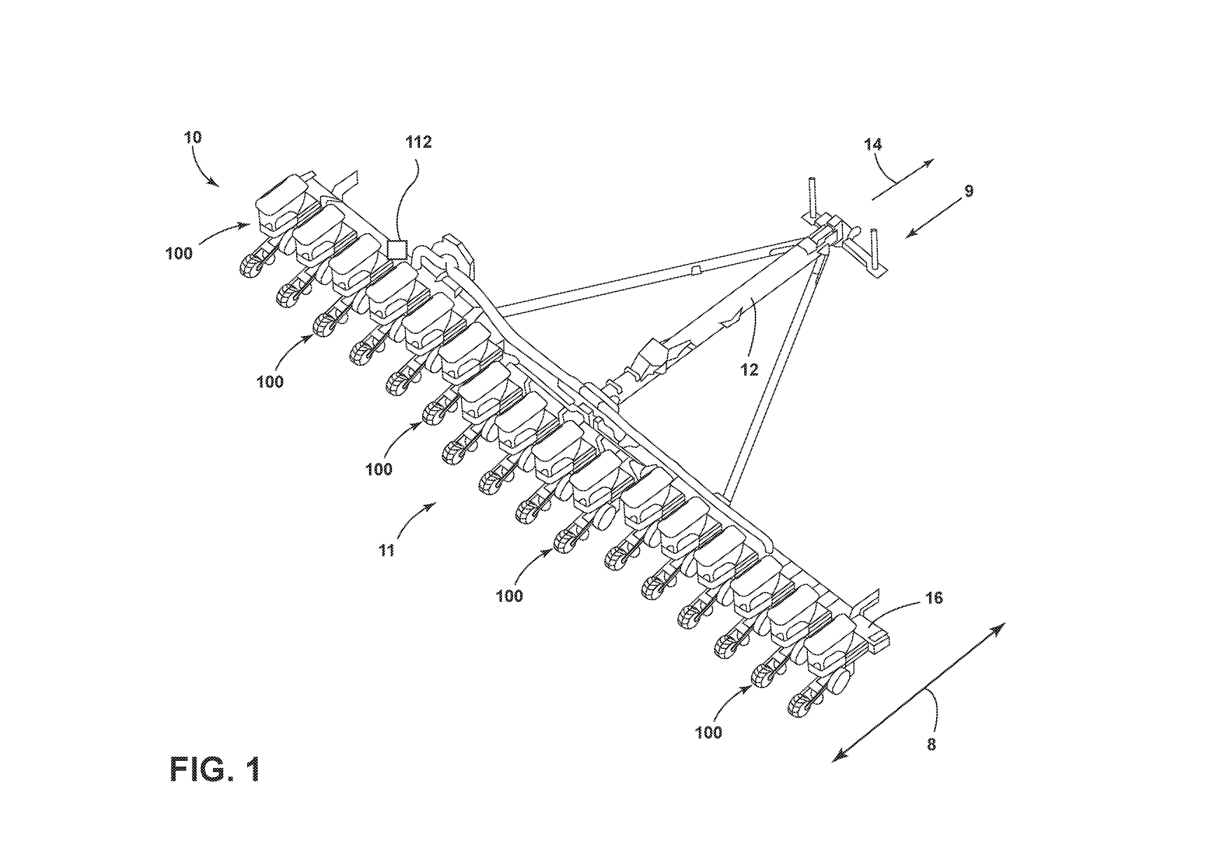

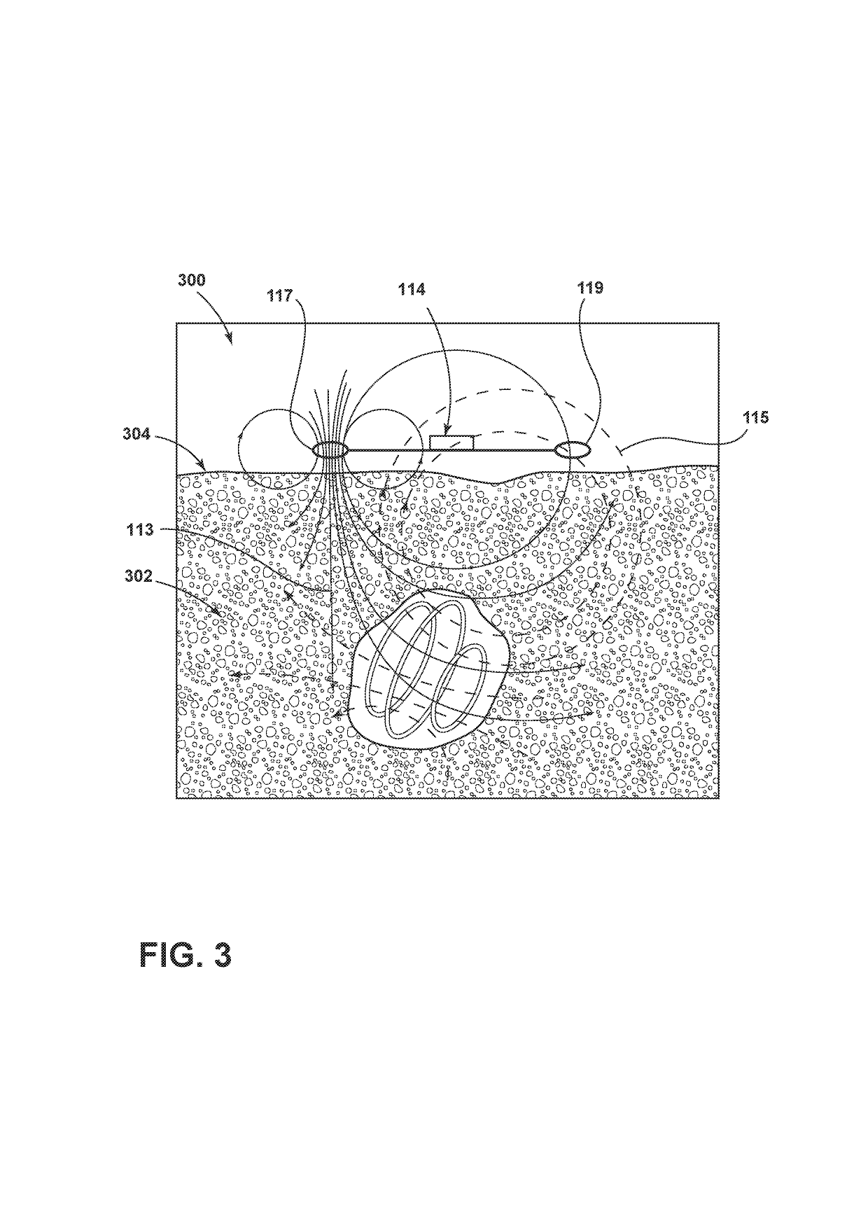

Referring now to the drawings, FIG. 1 illustrates a perspective view of one embodiment of a seed-planting implement 10 and FIG. 2 illustrates a side view of one embodiment of a row unit 100 of seed-planting implement 10 in accordance with aspects of the present subject matter. As shown in FIG. 1, the seed-planting implement 10 is configured as a planter. However, in alternative embodiments, the seed-planting implement 10 may generally correspond to any suitable seed-planting equipment or implement, such as a seeder or another seed-dispensing implement.

As shown in FIG. 1, the seed-planting implement 10 extends between a forward end 9 and an aft end 11 in a longitudinal direction (indicated by arrow 8). The seed-planting implement 10 includes a tow bar 12. In general, the tow bar 12 is configured to couple to a tractor or other agricultural vehicle (not shown), such as via a suitable hitch assembly (not shown). In this respect, the tractor may tow the seed-planting implement 10 across a field in a direction of travel (indicated by arrow 14) to perform a seed-planting operation on the field.

Furthermore, the seed-planting implement 10 includes a toolbar 16 coupled to the aft end of the tow bar 12. More specifically, the toolbar 16 is configured to support and/or couple to one or more components of the seed-planting implement 10. For example, the toolbar 16 is configured to support one or more seed-planting units or row units 100. As will be described below, each row unit 100 is configured to form a furrow having a selected depth within the soil of the field. Thereafter, each row unit 100 deposits seeds within the corresponding furrow and subsequently closes the corresponding furrow after the seeds have been deposited, thereby establishing rows of planted seeds. In some embodiments, the bulk of the seeds to be planted may be stored in one or more bulk storage containers or central hoppers (not shown) supported on the toolbar 16 and/or the tow bar 12. Thus, as seeds are planted by the row units 100, a pneumatic distribution system (not shown) may distribute seeds from the central hopper(s) to the individual row units 100.

In general, the seed-planting implement 10 may include any number of row units 100. For example, in the illustrated embodiment, the seed-planting implement 10 includes sixteen row units 100 coupled to the toolbar 16. However, in other embodiments, the seed-planting implement 10 may include six, eight, twelve, twenty-four, thirty-two, or thirty-six row units 100. In addition, the lateral spacing between row units 100 may be selected based on the type of crop being planted. For example, the row units 100 may be spaced approximately thirty inches from one another for planting corn and approximately fifteen inches from one another for planting soybeans.

As shown in FIG. 2, each row unit 100 of the seed-planting implement 10 may include a row unit frame 102 adjustably coupled to the toolbar 16 by links 24. For example, one end of each link 24 may be pivotably coupled to the row unit frame 102, while an opposed end of each link 24 may be pivotably coupled to the toolbar 16. However, in alternative embodiments, the row unit 100 may be coupled to the toolbar 16 in any other suitable manner. Furthermore, one or more seed reservoirs 101, such as a primary seed hopper 104, may be coupled to or otherwise supported on the row unit frame 102 and configured to store seeds (e.g., that are received from a bulk storage containers or filled individually).

Additionally, the row unit 100 includes one or more ground-engaging tools configured to prepare and/or finish the soil during a seed planting operation. For example, as shown in FIG. 2, the row unit 100 includes a residue removal device 26 pivotably coupled to the row unit frame 102 at its forward end relative to the direction of travel 14. In general, the residue removal device 26 may be configured to break up and/or sweep away or otherwise remove residue, dirt clods, and/or the like from the path of the row unit 100. As such, in several embodiments, the residue removal device 26 may include a pair of wheels 28 (one is shown), with each wheel 28 having a plurality of tillage points or fingers 30. As such, the wheels 28 may be configured to roll relative to the soil as the seed-planting implement 10 travels across the field such that the fingers 30 break up and/or sweep away residue and dirt clods. Additionally, the residue removal device 26 may include a support arm 32 that adjustably couples the wheels 28 to the row unit frame 102. For example, one end of the support arm 32 may be pivotably coupled to the wheels 28 via an axle 34, while an opposed end of the support arm 32 may be pivotably coupled to the row unit frame 102 via a pivot joint 36. However, in alternative embodiments, the residue removal device 26 may have any other suitable configuration. For example, in one embodiment, the residue removal device 26 may include only a single wheel 28.

Furthermore, the ground-engaging tool(s) of the row unit 100 may include one or more ground-engaging tools positioned aft of the residue removal device 26 relative to the direction of travel 14. As such, the ground-engaging tool(s) may be configured to interact with soil at a location(s) aft of the residue removal device 26. In this respect, and as will be described below, the ground-engaging tool(s) may facilitate the formation and subsequent closing of a furrow or trench within the soil into which seeds are deposited.

In several embodiments, the ground-engaging tool(s) may include an opening assembly 38 supported on the row unit frame 102. In general, the opening assembly 38 may be configured to form the furrow or trench within the soil. More specifically, in some embodiments, the opening assembly 38 may include a gauge wheel 40 adjustably coupled to the row unit frame 102 via a support arm 42. Furthermore, the opening assembly 38 may also include one or more opener disks 44 configured to excavate a furrow or trench within the soil. Thus, as the seed-planting implement 10 travels across the field, the gauge wheel 40 may be configured to engage the top surface of the soil. In this respect, the position of the gauge wheel 40 relative to the row unit frame 102 may set the penetration of the opener disk(s) 44 (and, thus, the depth of the furrow being excavated).

Moreover, in several embodiments, the ground-engaging tool(s) may include a closing assembly 46 supported on the row unit frame 102. In general, the closing assembly 46 may be configured to close the furrow or trench within the soil by the opening assembly 38. Specifically, in some embodiments, the closing assembly 46 may include a pair of closing disks 48 (one is shown) adjustably coupled to the row unit frame 102 via a support arm 50. In this respect, the closing disks 48 may be positioned relative to each other such that soil flows between the disks 48 as the seed-planting implement 10 travels across the field. As such, the closing disks 48 may be configured to collapse or otherwise close the furrow after seeds have been deposited therein, such as by pushing the excavated soil into the furrow. However, in alternative embodiments, the closing assembly 46 may have any other suitable configuration. For example, in one embodiment, the closing assembly 46 may have closing wheels (not shown) in lieu of the closing disks 48.

Furthermore, in several embodiments, the ground-engaging tool(s) may include a press wheel assembly 52 supported on the row unit frame 102. Specifically, in some embodiments, the press wheel assembly 52 may include a press wheel 54 adjustably coupled to the row unit frame 102 via a support arm 56. In this respect, as the seed-planting implement 10 travels across the field, the press wheel 54 may roll over the closed furrow to firm the soil over the seed and promote favorable seed-to-soil contact. However, in alternative embodiments, the press wheel assembly 52 may have any other suitable configuration.

Additionally, in alternative embodiments, the row unit 100 may include any other suitable ground-engaging tools in addition to or in lieu of the opening assembly 38, the closing assembly 46, and the press wheel assembly 52. Moreover, in some embodiments, the row unit 100 may include only the opening assembly 38 and the closing assembly 46.

As shown, the row unit 100 may include one or more actuators configured to adjust one or more operating parameters of the ground-engaging tool(s). For example, the actuator(s) may be configured to adjust the position of the ground-engaging tool(s) relative to the row unit frame 102 and/or the force being applied to the ground-engaging tool(s). As such, the actuator(s) may correspond to any suitable type of actuator(s), such as a fluid-driven actuator(s) (e.g., a pneumatic cylinder(s)).

In the illustrated embodiment, the row unit 100 includes an opening assembly actuator 106, a closing assembly actuator 108, and a press wheel assembly actuator 110. In this respect, the opening assembly actuator 106 may be configured to adjust one or more operating parameters of the gauge wheel 40, such as the force being applied to the gauge wheel 40 and/or the position of the gauge wheel 40 relative to the row unit frame 102 (which, in turn, adjust the penetration depth of the opener disk(s) 44). Moreover, the closing assembly actuator 108 may be configured to adjust one or more operating parameters of the closing disks 48, such as the force being applied to and/or the position relative to the row unit frame 102 (which may, in turn, adjust the penetration depth) of the closing disks 48. Additionally, the press wheel assembly actuator 110 may be configured to adjust one or more operating parameters of the press wheel 54, such as the force being applied to the press wheel 54. However, in alternative embodiments, the row unit 100 may include any other suitable actuator(s) and/or the actuator(s) may be configured to adjust any other suitable operating parameters of the ground-engaging tool(s).

Moreover, a location sensor 112 may be provided in operative association with the seed-planting implement 10. For instance, as shown in FIGS. 1 and 2, the location sensor 112 is installed on or within the seed-planting implement 10, such as on the toolbar 16 of the seed-planting implement 10. In general, the location sensor 112 may be configured to determine the current location of the seed-planting implement 10 using a satellite navigation positioning system (e.g., a GPS system, a Galileo positioning system, the Global Navigation satellite system (GLONASS), the BeiDou Satellite Navigation and Positioning system, and/or the like). In such an embodiment, the location determined by the location sensor 112 may be transmitted to a computing system of the seed-planting implement 10 (e.g., in the form coordinates) and stored within the computing system’s memory for subsequent processing and/or analysis. For instance, based on the known dimensional configuration and/or relative positioning between the seed-planting implement 10 and the vehicle towing the seed-planting implement 10, the determined location from the location sensor 112 may be used to geo-locate the seed-planting implement 10 within the field.

Furthermore, one or more non-contact-based sensors 114 may be provided in operative association with the seed-planting implement 10. In general, the non-contact-based sensor(s) 114 may be configured to capture data indicative of the subsurface soil as the seed-planting implement 10 travels across the field. As will be described below, the data captured by the non-contact-based sensor(s) 114 may be used to determine when an air pocket is present between a seed planted within the subsurface soil and the subsurface soil. In this respect, the non-contact-based sensor(s) 114 may be a non-contact-based sensor(s) installed or otherwise supported on the seed-planting implement 10 such that the sensor(s) has a field of view or sensor detection range directed towards a portion of the field adjacent to the seed-planting implement 10. For example, as shown in FIG. 2, in one embodiment, the non-contact-based sensor(s) 114 may be mounted on the aft end 11 of the seed-planting implement 10, such as behind the press wheel 54, to capture data associated with a portion of the soil within the field disposed behind the seed-planting implement 10 relative to the direction of travel 14. However, in alternative embodiments, the non-contact-based sensor(s) 114 may be installed at any other suitable location(s) on the seed-planting implement 10. Additionally, the seed-planting implement 10 may include any suitable number of non-contact-based sensors, such as a single non-contact-based sensor or two or more non-contact-based sensors.

The configuration of the seed-planting implement 10 described above and shown in FIGS. 1 and 2 is provided only to place the present subject matter in an exemplary field of use. Thus, the present subject matter may be readily adaptable to any manner of seed-planting implement configuration.

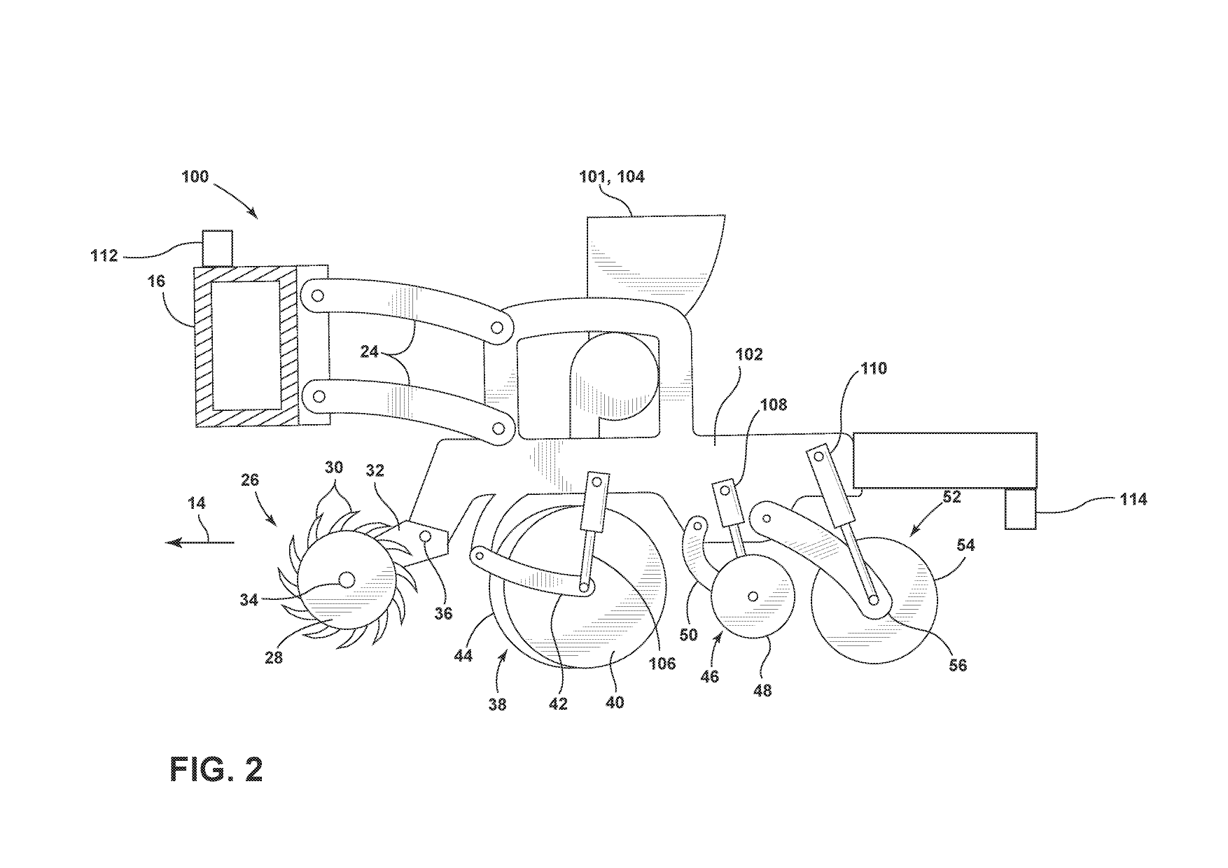

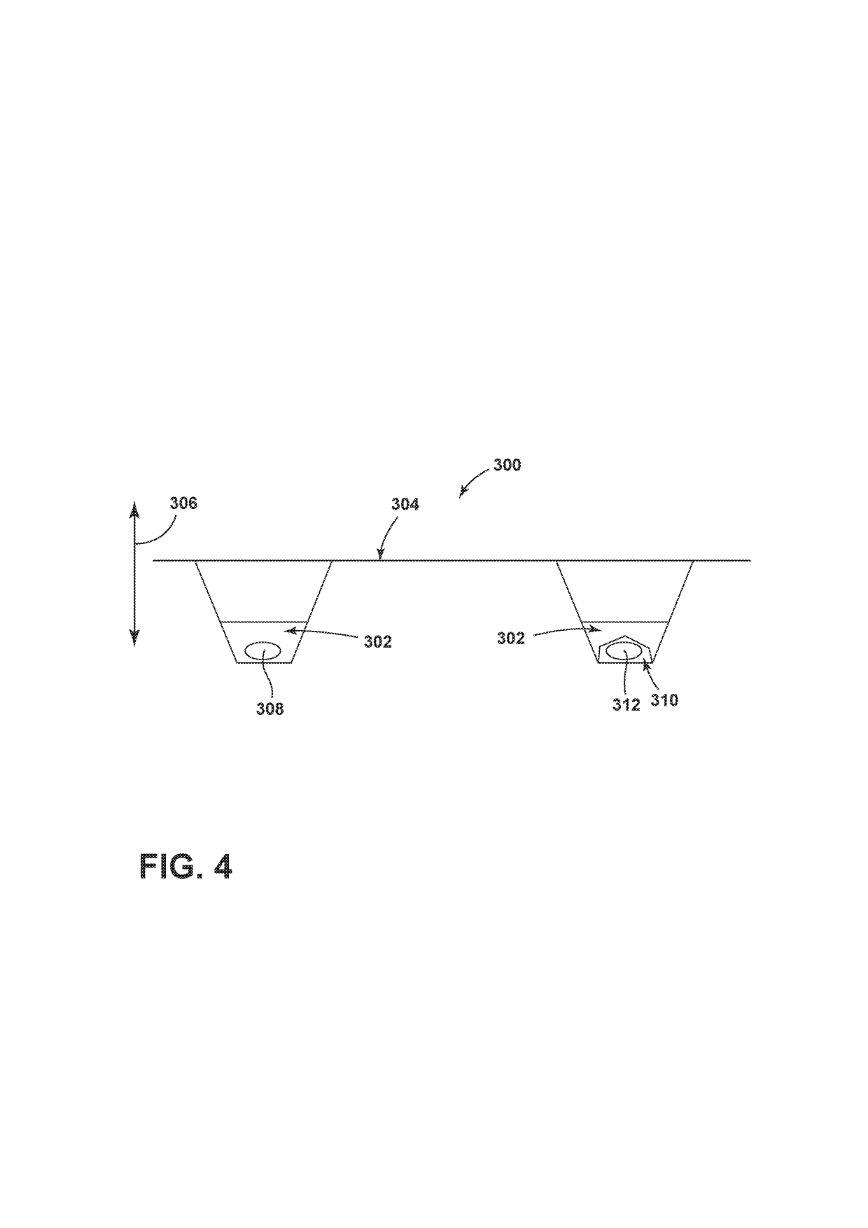

Referring now to FIGS. 3 and 4, cross-sectional views of a portion of the soil within an agricultural field 300 are illustrated in accordance with aspects of the present subject matter. Specifically, FIG. 3 illustrates an example cross-sectional view of a portion of the soil within the agricultural field 300 and an embodiment of a non-contact-based sensing device 114 that may be used with a seed-planting implement. FIG. 4 illustrates an example cross-sectional view of a portion of the soil within the agricultural field 300 is illustrated, particularly illustrating the subsurface soil and air pockets within the subsurface soil.

As shown in FIG. 3, the non-contact-based sensor(s) 114 may include a transmitter portion 117 (e.g., coil). The transmitter portion 117 may be configured to emit one or more electromagnetic outputs 113 generated by the non-contact-based sensor(s) 114. The electromagnetic output(s) 113 may be directed, for example, toward a portion of the soil within its field of view or sensor detection zone. For example, in some embodiments, the non-contact-based sensor(s) 114 may be configured as a ground-penetrating radar (GPR) sensing device(s) configured to emit radio wave output signals directed toward the portion of the soil within its field of view or sensor detection zone. Additionally, or alternatively, in some embodiments, the non-contact-based sensor(s) 114 may be configured as a low induction number (LIN) sensing device(s) configured to emit a generated electromagnetic field within the soil of the field.

The GPR sensing device(s) may be configured to capture GPR data associated with the soil present within the field of view or sensor detection range of the GPR sensing device(s) using radio wave output signals. For example, the GPR sensing device(s) may utilize radio wave output signals emitted within a low frequency range, such as a frequency range within 5 kilohertz to 16 kilohertz, to capture data associated with the soil. However, it should be appreciated that the radio wave output signals emitted by the GPR sensing device(s) may be emitted at any other suitable frequency range, such as a frequency range within 4 kilohertz to 18 kilohertz. The captured GPR data may be used to determine the property(ies) of the subsurface soil, which, in turn, allows the presence of air pockets to be determined between seeds planted within the subsurface soil and the subsurface soil. For example, the GPR data may allow a representation, such as a two-dimensional and/or three-dimensional representation, of the subsurface soil to be generated. As will be described below, in some embodiments, the representation may be used to determine the property(ies) of the subsurface soil. Additionally, or alternatively, the LIN sensing device(s) may be used to capture LIN data associated with the soil within the field utilizing generated electromagnetic fields. The captured LIN data may be used to determine the property(ies) of the subsurface soil, which, in turn, allows the presence of air pockets to be determined between seeds planted within the subsurface soil and the subsurface soil.

The non-contact-based sensor(s) 114 may include a receiver portion 119 (e.g., coil). The receiver portion 119 may be configured to receive the electromagnetic output(s) 113. For example, in some embodiments, at least a portion of the radio wave output signals emitted by the GPR sensing device(s) may be reflected by the subsurface soil as echo signals. The echo signals may be received by the receiver portion 119. In this regard, the time of flight, amplitude, frequency, and/or phase of the received echo signals may be used to determine the property(ies) of the subsurface soil, such as the relative permittivity value(s) of the subsurface soil, the electrical conductivity value(s) of the subsurface soil, and/or other properties associated with the subsurface soil. For example, the time of flight, amplitude, frequency, and/or phase of the received echo signals may be used to generate the representation of the subsurface soil from which the property(ies) of the subsurface soil may then be determined.

Additionally, or alternatively, in some embodiments, the LIN sensing device(s) may emit a generated primary electromagnetic field. The generated primary electromagnetic field emitted may be modified or “distorted” after passing through a medium, such as the soil of the field. For example, the modified primary electromagnetic field may appear as or imitate eddy currents/circular currents. The modified primary electromagnetic field, which is called a secondary electromagnetic field, may be received by the receiver portion 119. In this regard, as will be described below, the strength of the received secondary electromagnetic field may be determined and used to determine the property(ies) of the subsurface soil, such as the relative permittivity value(s) of the subsurface soil, the electrical conductivity value(s) of the subsurface soil, and/or other properties associated with the subsurface soil.

Furthermore, as shown in FIG. 3, the transmitter portion 117 and the receiver portion 119 of the non-contact-based sensing device(s) 114 are horizontally spaced apart from each other. However, it should be appreciated that, in some embodiments, the transmitter portion 117 and the receiver portion 119 may also, or alternatively, be vertically spaced apart from each other. For example, in some embodiments, the transmitter portion 117 and the receiver portion 119 may be vertically aligned. In this respect, the transmitter portion 117 may be vertically positioned directly over the receiver portion 119 in the or the receiver portion 119 may be vertically positioned directly over the transmitter portion 117. Alternatively, in some other embodiments, the transmitter portion 117 and the receiver portion 119 may be vertically spaced apart, but not aligned. In this respect, the transmitter portion 117 may be vertically positioned above the receiver portion 119, or the receiver portion 119 may be vertically positioned above the transmitter portion 117, while the transmitter portion 117 and the receiver portion 119 are also horizontally spaced apart from each other. Additionally, in some embodiments, the positions, such as the orientations or the linear positions, of the transmitter portion 117 and/or the receiver portion 119 may be adjustable relative to each other. As such, the depth within the ground at which the data is captured by the non-contact-based sensor(s) 114 may be increased and/or decreased.

As shown in FIGS. 3 and 4, the field 300 includes subsurface soil 302. The subsurface soil 302 extends from a top surface 304 of the field 300 downward in a vertical direction (indicated by arrow 306 in FIG. 4). As particularly shown in FIG. 4, seeds may be planted within the subsurface soil 302, such as below the top surface 304 of the field 300. For example, some of the seeds, such as a first seed 308, may contact the subsurface soil 302, which surrounds the seeds. However, during or after soil packing, an air pocket 310 (FIGS. 3, 4) may form. For example, as shown in FIG. 4, the air pocket 310 may form around the seeds, such as around a second seed 312. As such, an air gap may be defined between the second seed 312 and the subsurface soil 302. The air pocket 310 positioned between the second seed 312 planted within the subsurface soil 302 and the subsurface soil 302 may result in unfavorable seed-to-soil contact and, thus, an undesirable crop yield. In this respect, it is generally desirable for the force applied to the ground-engaging tool(s) (e.g., the press wheel(s) 54, closing disk(s) 48) of the seed-planting implement 10 to be increased so that the subsurface soil 302 is packed more tightly to close existing air pockets and/or inhibit formation of new air pockets.

In general, subsurface soil without air pockets positioned between planted seeds and surrounding subsurface soil may have different properties than subsurface soil with air pockets positioned between planted seeds and surrounding subsurface soil. For example, subsurface soil with air pockets positioned between planted seeds and surrounding subsurface soil may have a lower relative permittivity value than subsurface soil with no air pockets or may have a lower or higher relative permittivity value than subsurface soil with air pockets but no planted seeds. Additionally, subsurface soil with air pockets positioned between planted seeds and surrounding subsurface soil may have a lower electrical conductivity value than subsurface soil with no air pockets and may have a lower or higher electrical conductivity value than subsurface soil with air pockets but no planted seeds. In this respect, in some embodiments, the reflected echo signals from the radio wave output signals emitted by the GPR sensing device(s) at subsurface soil containing one or more air pockets 310 may be utilized to determine property(ies) of the subsurface soil 302, and, in turn, utilized to determine the presence of one or more of the air pockets 310 between seeds planted within the subsurface soil 302 and the subsurface soil 302. Thus, using the property(ies) of the subsurface soil 302 allows for determination of the presence of the air pockets 310 between the seeds planted within the subsurface soil 302 and the subsurface soil 302. Additionally, or alternatively, in some embodiments, the secondary electromagnetic field received by the LIN sensing device(s) may be utilized to determined property(ies) of the subsurface soil 302, and, in turn, utilized to determine the presence of one or more of the air pockets 310 between seeds planted within the subsurface soil 302 and the subsurface soil 302.

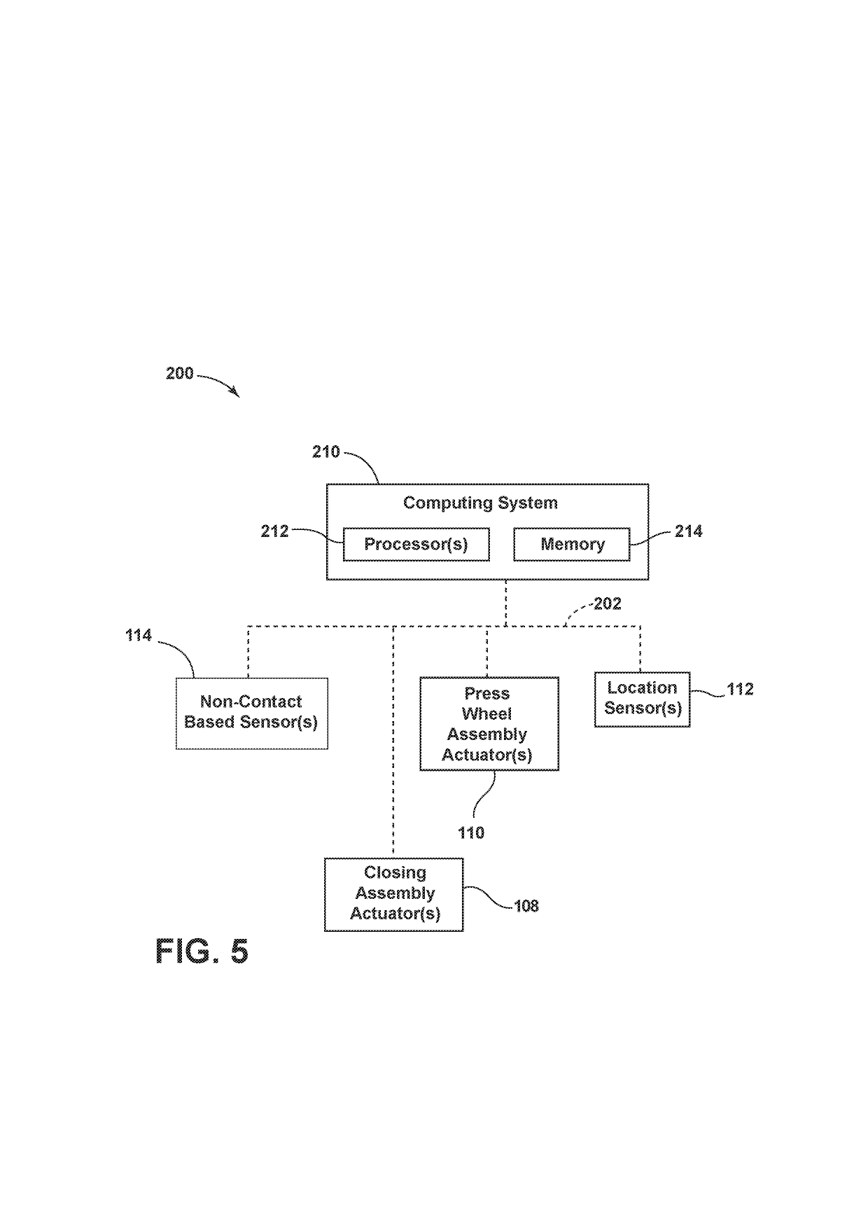

Referring now to FIG. 5, a schematic view of one embodiment of a system 200 for detecting air pockets within a field is illustrated in accordance with aspects of the present subject matter. In general, the system 200 will be described herein with reference to the seed-planting implement 10 and the non-contact-based sensing device(s) 114 described above with reference to FIGS. 1-4. However, it should be appreciated by those of ordinary skill in the art that the disclosed system 200 may generally be utilized with agricultural implements having any other suitable implement configuration.

As shown in FIG. 5, the system 200 may include the non-contact-based sensor(s) 114 provided in operative association with the seed-planting implement 10. In several embodiments, each non-contact-based sensor(s) 114 may include the GPR sensing device(s) and/or the LIN sensing device(s).

In accordance with aspects of the present subject matter, the system 200 may include a computing system 210 communicatively coupled to one or more components of the seed-planting implement 10 and/or the system 200 to allow the operation of such components to be electronically or automatically controlled by the computing system 210. For instance, the computing system 210 may be communicatively coupled to the location sensor 112 via a communicative link 202. As such, the computing system 210 may be configured to receive location data from the location sensor 112 that is indicative of the location of the seed-planting implement 10 within the field. Furthermore, the computing system 210 may be communicatively coupled to the non-contact-based sensor(s) 114 via the communicative link 202. As such, the computing system 210 may be configured to receive data from the non-contact-based sensor(s) 114 that is indicative of the subsurface soil as the seed-planting implement 10 travels across the field. Additionally, the computing system 210 may be communicatively coupled to the closing assembly actuator(s) 108 via the communicative link 202. In this respect, the computing system 210 may be configured to control the operation of the closing assembly actuator(s) 108 in a manner that controls adjustment of one or more operating parameters of the closing assembly(ies) 46, such as the force being applied to the closing disk(s) 48. Moreover, the computing system 210 may be communicatively coupled to the press wheel assembly actuator(s) 110 via the communicative link 202. In this respect, the computing system 210 may be configured to control the operation of the press wheel assembly actuator(s) 110 in a manner that controls adjustment of one or more operating parameters of the press wheel assembly(ies) 52, such as the force being applied to the press wheel(s) 54. Additionally, the computing system 210 may be communicatively coupled to any other suitable components of the seed-planting implement 10 and/or the system 200.

In general, the computing system 210 may comprise any suitable processor-based device known in the art, such as a given controller or computing device or any suitable combination of controllers or computing devices. Thus, in several embodiments, the computing system 210 may include one or more processor(s) 212 and associated memory device(s) 214 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 214 of the computing system 210 may generally comprise memory element(s) including, but not limited to, a computer readable medium (e.g., random access memory (RAM)), a computer readable non-volatile medium (e.g., a flash memory), a floppy disc, a compact disc-read only memory (CD-ROM), a magneto-optical disc (MOD), a digital versatile disc (DVD), and/or other suitable memory elements. Such memory device(s) 214 may generally be configured to store suitable computer-readable instructions that, when implemented by the processor(s) 212, configure the computing system 210 to perform various computer-implemented functions, such as one or more aspects of the methods and algorithms that will be described herein. In addition, the computing system 210 may also include various other suitable components, such as a communications circuit or module, one or more input/output channels, a data/control bus and/or the like.

It should be appreciated that the computing system 210 may correspond to an existing computing system(s) of the seed-planting implement 10 and/or the work vehicle (not shown), itself, or the computing system 210 may correspond to a separate processing device. For instance, in one embodiment, the computing system 210 may form all or part of a separate plug-in module that may be installed in association with the seed-planting implement 10 and/or work vehicle to allow for the disclosed systems to be implemented without requiring additional software to be uploaded onto existing control devices of the seed-planting implement 10 and/or work vehicle.

Furthermore, it should also be appreciated that the functions of the computing system 210 may be performed by a single processor-based device or may be distributed across any number of processor-based devices, in which instance such devices may be considered to form part of the computing system 210. For instance, the functions of the computing system 210 may be distributed across multiple application-specific controllers or computing devices, such as a navigation controller, an engine computing controller, a transmission controller, an implement controller and/or the like.

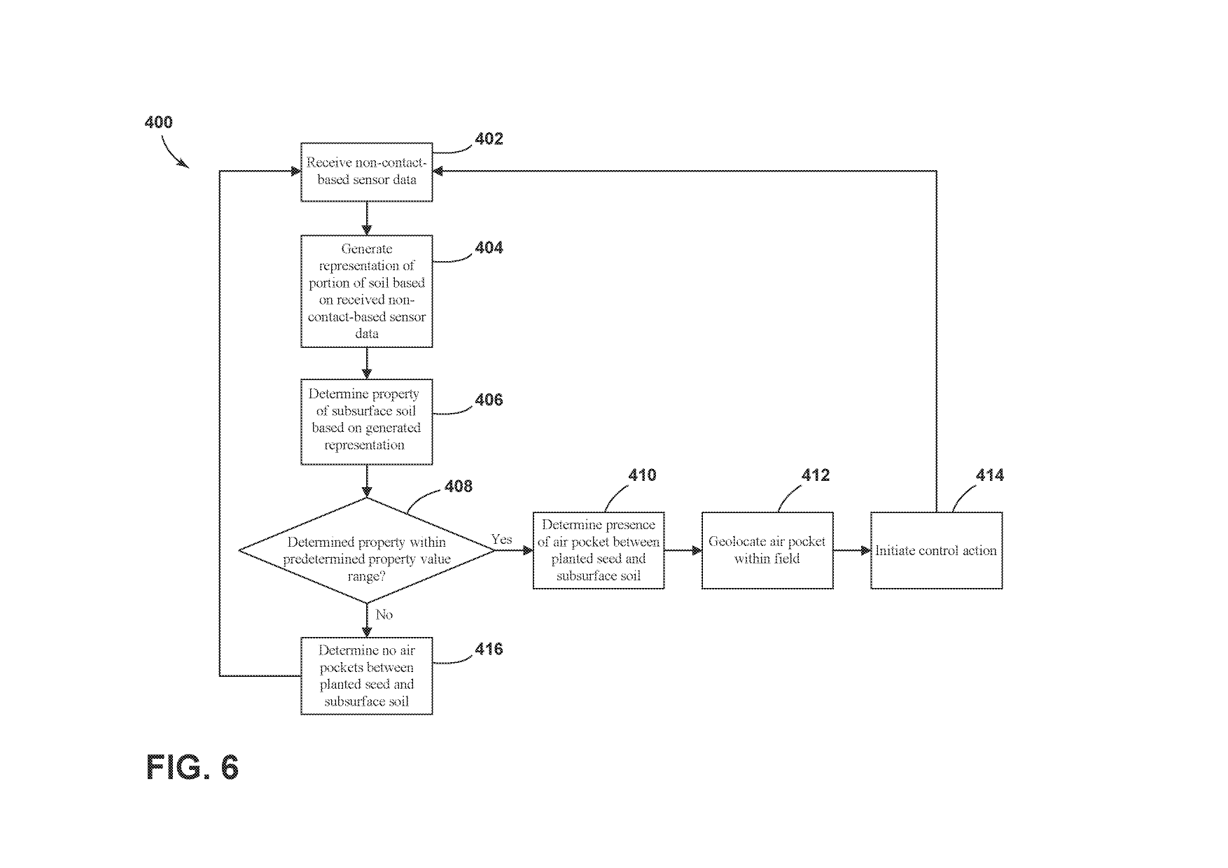

Referring now to FIG. 6, a flow diagram of a first embodiment of example control logic 400 that may be executed by the computing system 210 (or any other suitable computing system) for detecting air pockets within a field is illustrated in accordance with aspects of the present subject matter. Specifically, the control logic 400 shown in FIG. 6 is representative of steps of one embodiment of an algorithm that can be executed to determine the presence of air pockets between subsurface soil and planted seeds, thereby improving the quality of a seed planting operation as field conditions vary. Thus, in several embodiments, the control logic 400 may be advantageously utilized in association with a system installed on or forming part of a seed-planting implement to allow for real-time control of the implement without requiring substantial computing resources and/or processing time. However, in other embodiments, the control logic 400 may be used in association with any other suitable system, application, and/or the like for detecting air pockets.

As shown in FIG. 6, at (402), the control logic 400 includes receiving non-contact-based sensor data indicative of subsurface soil of soil of a field. For example, as indicated above, the computing system 210 may be communicatively coupled to the non-contact-based sensor(s) 114 of the seed-planting implement 10 via the communicative link 202. In this respect, as the seed-planting implement 10 travels across a field to perform a seed planting operation on the field, the computing system 210 may be configured to receive data from the non-contact-based sensor(s) 114 that is indicative of the subsurface soil, such as data associated with reflected echo signals and/or data associated with the secondary electromagnetic field.

Furthermore, at (404), the control logic 400 includes generating a representation of a portion of the soil within the field based on the received non-contact-based sensor data. Specifically, in several embodiments, the computing system 210 may be configured to analyze/process the received sensor data (e.g., the sensor data received at (402)) to generate a representation of a portion of the soil within the field. As such, the computing system 210 may include a suitable algorithm(s) stored within its memory device(s) 214 that, when executed by the processor(s) 212, generates the representation from the data received from the sensor(s) 114.

The representation of the portion of the soil within the field may correspond to any suitable data structure that depicts or otherwise provides an indication of the subsurface soil based on the received non-contact-based sensor data. For example, in several embodiments, the representation of the subsurface soil may correspond to a two-dimensional or three-dimensional image(s) illustrating or depicting the subsurface soil. In this respect, the generated representation may provide an indication of various parameters or properties associated with the subsurface soil present within the field across which the seed-planting implement 10 is traveling. For example, such properties may include the relative permittivity value(s) of the subsurface soil, the electrical conductivity value(s) of the subsurface soil, and/or the like. However, in alternative embodiments, the representation of the subsurface soil may correspond to any other suitable type of data structure, such as one-dimensional representation or dataset.

Additionally, at (406), the control logic 400 includes determining the property of the subsurface soil based on the generated representation. For example, in one embodiment, the computing system 210 may be configured to analyze the generated representation of the subsurface soil (e.g., the representation generated at (404)) to the determine the property(ies) of the subsurface soil (e.g., electrical property(ies)). In such an embodiment, the computing system 210 may use any suitable technique(s) or algorithm(s) to determine the property(ies) of the subsurface soil based on the generated representation. For example, the computing system 210 may utilize a geophysical inversion model to determine the property(ies) of the subsurface soil. The inversion model may correspond to a mathematical prediction of the property(ies) of the subsurface soil based on raw data of the subsurface soil. Alternatively, in other embodiments, the computing system 210 may determine the property(ies) of the subsurface soil directly based on the received non-contact-based sensor data (e.g., the sensor data received at (402)). For example, the computing system 210 may determine the property(ies) of the subsurface soil based on the time of flight of the signal(s) 113 emitted by the GPR sensing device(s).

In some embodiments, determining the property of the subsurface soil may include determining a relative permittivity value of the subsurface soil. Additionally, or alternatively, in some embodiments, determining the property of the subsurface soil may include determining an electrical conductivity value of the subsurface soil.

Moreover, as shown in FIG. 6, at (408), the control logic 400 includes comparing the determined property of the subsurface soil to a predetermined property value range. More specifically, the computing system 210 may compare the determined property(ies) of the subsurface soil (e.g., the property(ies) determined at (406)) to a predetermined property value range. As mentioned above, the property(ies) of subsurface soil containing an air pocket(s) positioned between the seeds planted within the subsurface soil and the subsurface soil is generally different than the property(ies) of subsurface soil containing no air pocket(s) or subsurface soil containing air pocket(s) but no planted seeds. In this respect, when the determined property(ies) of the subsurface soil falls within the predetermined property value range, the computing system 210 may determine (e.g., at (410)) that the air pocket(s) is present between the seed(s) planted within the subsurface soil and the subsurface soil. Thereafter, the control logic 400 may proceed to (412). Conversely, when the determined property(ies) of the subsurface soil is equal to or falls outside of the predetermined property value range, the computing system 210 may determine (e.g., at (416)) that there are no air pocket(s) within the subsurface soil present or positioned between the seed(s) planted within the subsurface soil and the subsurface soil. Thereafter, the control logic 400 may return to (402).

Furthermore, at (412), when determined that the air pocket is present/positioned between the seed planted within the subsurface soil and the subsurface soil, the control logic 400 includes geo-locating the air pocket within the field. More specifically, as the seed-planting implement 10 travels across the field, the computing system 210 may be configured to receive location data (e.g., coordinates) from the location sensor 112 (e.g., via the communicative link 202). Based on the known dimensional configuration and/or relative positioning between the non-contact-based sensor(s) 114 and the location sensor 112, the computing system 210 may geo-locate each air pocket within the field. For example, in one embodiment, the coordinates derived from the location sensor 112 and the determination of the presence of the air pocket(s) may both be time-stamped. In such an embodiment, the time-stamped data may allow the determination of the presence of the air pocket(s) to be matched or correlated to a corresponding set of location coordinates received or derived from the location sensor 112. Moreover, in some embodiments, the computing system 210 may be configured to generate a field map identifying one or more locations within the field at which it is determined that the air pocket(s) is present.

In addition, at (414), when determined that the air pocket is present/positioned between the seed planted within the subsurface soil and the subsurface soil, the control logic 400 includes initiating a control action associated with adjusting a force applied to a ground-engaging tool. Specifically, in such instances, the computing system 210 may be configured to control the operation of the actuator(s) of one or more ground-engaging tools of the seed-planting implement 10 such that the force applied to the tool(s) by the actuator(s) and, thus, the force applied by the tool(s) to the field surface, is adjusted. For example, in some embodiments, the computing system 210 may transmit control signals to the press wheel assembly actuator(s) 110 and/or the closing assembly actuator(s) 108. The control signals may, in turn, instruct the press wheel assembly actuator(s) 110 and/or the closing assembly actuator(s) 108 to increase the force that the press wheel assembly actuator(s) 110 and/or the closing assembly actuator(s) 108 applies to the press wheel assembly(ies) 52 and the closing assembly(ies) 46 respectively and, thus, to the press wheel(s) 54 and the closing disk(s) 48 respectively. The increase in force applied to the press wheel(s) 54 and/or the closing disk(s) 48 may, in turn, pack the soil more tightly to close existing air pockets and/or inhibit formation of new air pockets. Thereafter, the control logic 400 returns to (402).

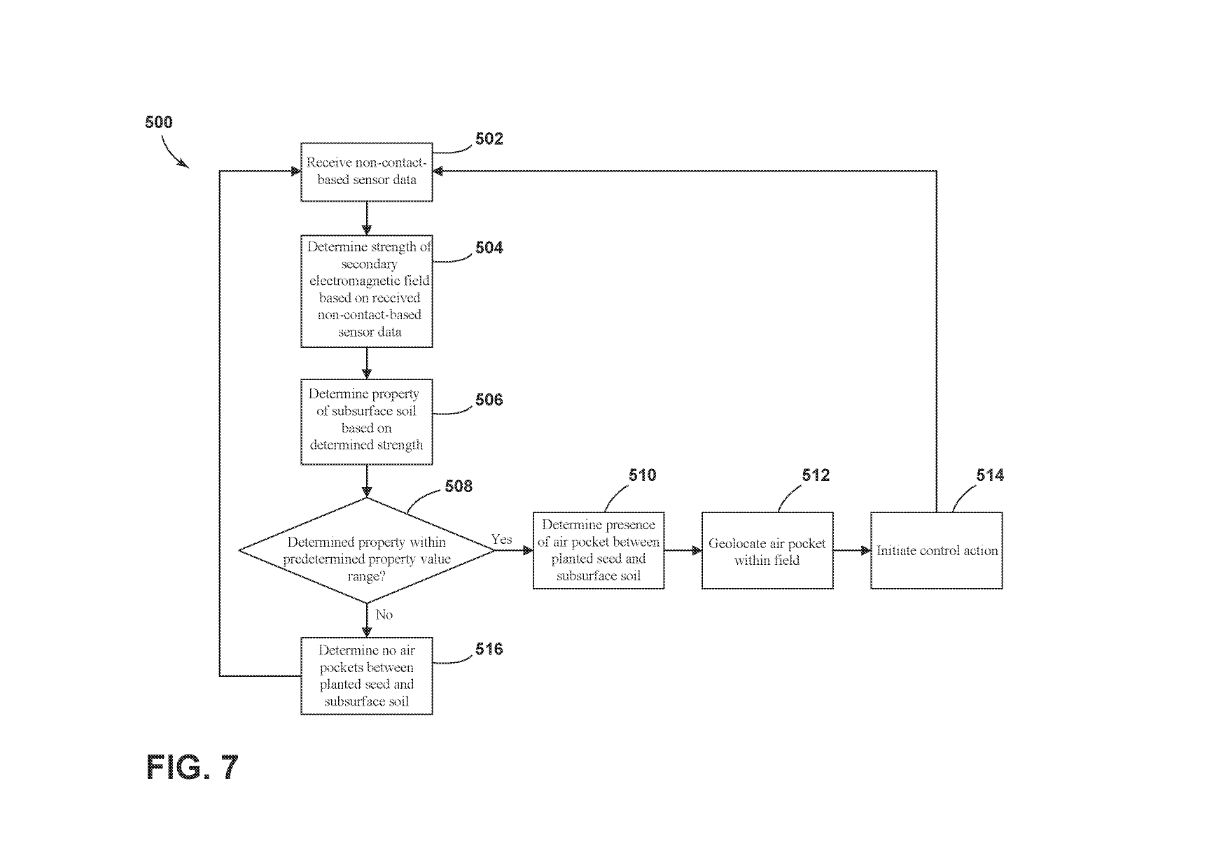

Referring now to FIG. 7, a flow diagram of one embodiment of example control logic 500 that may be executed by the computing system 210 (or any other suitable computing system) for detecting air pockets within a field is illustrated in accordance with aspects of the present subject matter. Specifically, the control logic 500 shown in FIG. 7 is representative of steps of a second embodiment of an algorithm that can be executed to determine the presence of air pockets between subsurface soil and planted seeds, thereby improving the quality of a seed planting operation as field conditions vary. Thus, in several embodiments, the control logic 500 may be advantageously utilized in association with a system installed on or forming part of a seed-planting implement to allow for real-time control of the implement without requiring substantial computing resources and/or processing time. However, in other embodiments, the control logic 500 may be used in association with any other suitable system, application, and/or the like for detecting air pockets.

As shown in FIG. 7, at (502), the control logic 500 includes receiving non-contact-based sensor data indicative of a secondary electromagnetic field induced by a generated primary electromagnetic field emitted at soil of a field. For example, as indicated above, the computing system 210 may be communicatively coupled to the non-contact-based sensor(s) 114 of the seed-planting implement 10 via the communicative link 202. In this respect, as the seed-planting implement 10 travels across a field to perform a seed planting operation on the field, the computing system 210 may be configured to receive data from the non-contact-based sensor(s) 114 that is indicative of the secondary electromagnetic field, such as data associated with a strength of the secondary electromagnetic field.

Furthermore, at (504), the control logic 500 includes determining a strength of the secondary electromagnetic field based on the received non-contact-based sensor data. Specifically, in several embodiments, the computing system 210 may be configured to analyze/process the received sensor data (e.g., the sensor data received at (502)) to determine the strength of the secondary electromagnetic field. As such, the computing system 210 may include a suitable algorithm(s) stored within its memory device(s) 214 that, when executed by the processor(s) 212, determines the strength of the secondary electromagnetic field from the data received from the sensor(s) 114. The determined strength of the secondary electromagnetic field may vary depending on variances in the medium through which the primary electromagnetic field passes. For example, variances in the subsurface soil properties may cause the determined strength of the secondary electromagnetic field, which is induced by the primary electromagnetic field, to vary.

Additionally, at (506), the control logic 500 includes determining a property of the subsurface soil based on the determined strength of the secondary electromagnetic field. For example, in one embodiment, the computing system 210 may be configured to analyze the strength of the secondary electromagnetic field determined at (504) to determine the property(ies) of the subsurface soil (e.g., electrical property(ies)). For example, the computing system 210 may access a lookup table stored within its memory device(s) 214 that correlates the determined strength of the secondary magnetic field to a property value(s) of the subsurface soil.

In some embodiments, determining the property of the subsurface soil may include determining a relative permittivity value of the subsurface soil. Additionally, or alternatively, in some embodiments, determining the property of the subsurface soil may include determining an electrical conductivity value of the subsurface soil.

Moreover, as shown in FIG. 7, at (508), the control logic 500 includes comparing the determined property of the subsurface soil to a predetermined property value range. More specifically, the computing system 210 may compare the determined property(ies) of the subsurface soil (e.g., the property(ies) determined at (506)) to a predetermined property value range. As mentioned above, the property(ies) of subsurface soil containing an air pocket(s) positioned between the seeds planted within the subsurface soil and the subsurface soil is generally different than the property(ies) of subsurface soil containing no air pocket(s) or subsurface soil containing air pocket(s) but no planted seeds. In this respect, when the determined property(ies) of the subsurface soil falls within the predetermined property value range, the computing system 210 may determine (e.g., at (510)) that the air pocket(s) is present between the seed(s) planted within the subsurface soil and the subsurface soil. Thereafter, the control logic 500 may proceed to (512). Conversely, when the determined property(ies) of the subsurface soil is equal to or falls outside of the predetermined property value range, the computing system 210 may determine (e.g., at (516)) that there are no air pocket(s) within the subsurface soil present or positioned between the seed(s) planted within the subsurface soil and the subsurface soil. Thereafter, the control logic 500 may return to (502).

Furthermore, at (512), when determined that the air pocket is present/positioned between the seed planted within the subsurface soil and the subsurface soil, the control logic 500 includes geo-locating the air pocket within the field. More specifically, as the seed-planting implement 10 travels across the field, the computing system 210 may be configured to receive location data (e.g., coordinates) from the location sensor 112 (e.g., via the communicative link 202). Based on the known dimensional configuration and/or relative positioning between the non-contact-based sensor(s) 114 and the location sensor 112, the computing system 210 may geo-locate each air pocket within the field. For example, in one embodiment, the coordinates derived from the location sensor 112 and the determination of the presence of the air pocket(s) may both be time-stamped. In such an embodiment, the time-stamped data may allow the determination of the presence of the air pocket(s) to be matched or correlated to a corresponding set of location coordinates received or derived from the location sensor 112. Moreover, in some embodiments, the computing system 210 may be configured to generate a field map identifying one or more locations within the field at which it is determined that the air pocket(s) is present.

In addition, at (514), when determined that the air pocket is present/positioned between the seed planted within the subsurface soil and the subsurface soil, the control logic 500 includes initiating a control action associated with adjusting a force applied to a ground-engaging tool. Specifically, in such instances, the computing system 210 may be configured to control the operation of the actuator(s) of one or more ground-engaging tools of the seed-planting implement 10 such that the force applied to the tool(s) by the actuator(s) and, thus, the force applied by the tool(s) to the field surface, is adjusted. For example, in some embodiments, the computing system 210 may transmit control signals to the press wheel assembly actuator(s) 110 and/or the closing assembly actuator(s) 108. The control signals may, in turn, instruct the press wheel assembly actuator(s) 110 and/or the closing assembly actuator(s) 108 to increase the force that the press wheel assembly actuator(s) 110 and/or the closing assembly actuator(s) 108 applies to the press wheel assembly(ies) 52 and the closing assembly(ies) 46 respectively and, thus, to the press wheel(s) 54 and the closing disk(s) 48 respectively. The increase in force applied to the press wheel(s) 54 and/or the closing disk(s) 48 may, in turn, pack the soil more tightly to close existing air pockets and/or inhibit formation of new air pockets. Thereafter, the control logic 500 returns to (502).

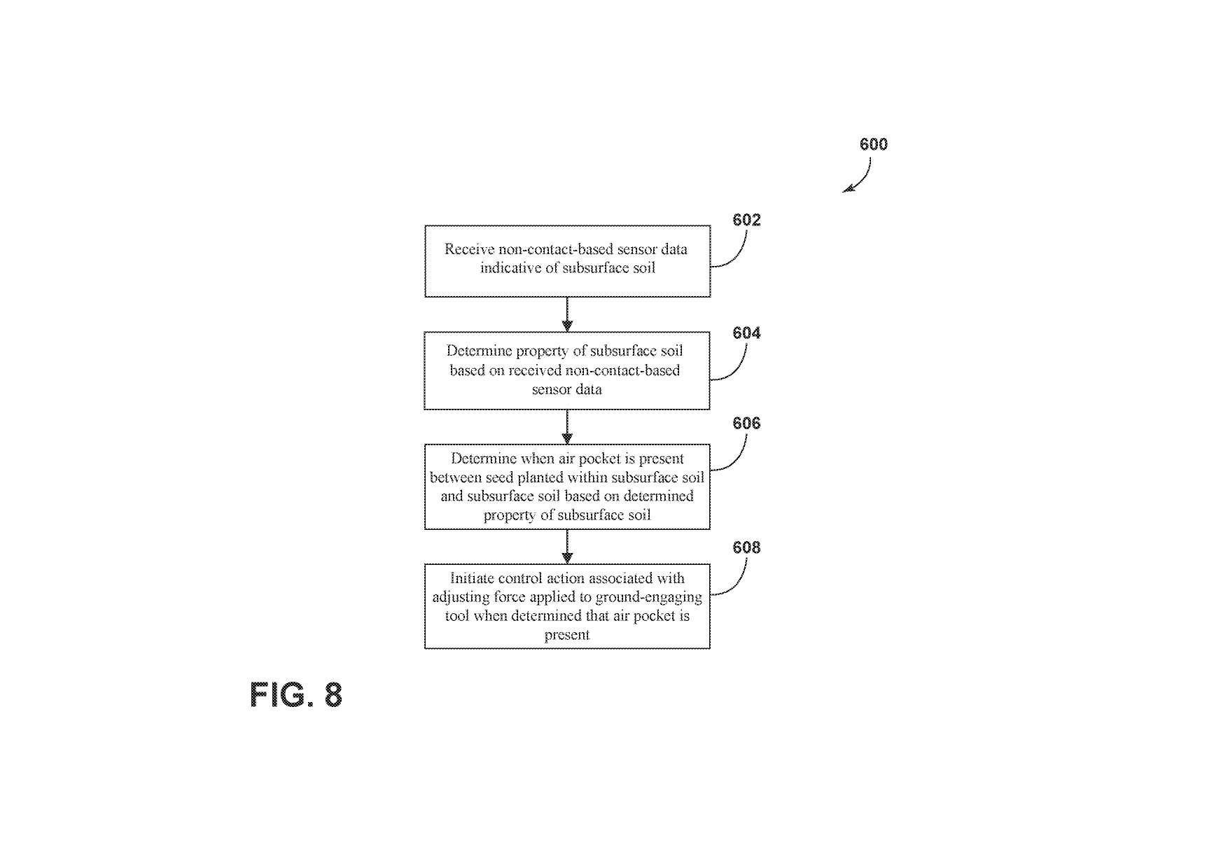

Referring now to FIG. 8, a flow diagram of one embodiment of a method 600 for detecting air pockets within a field is illustrated in accordance with aspects of the present subject matter. In general, the method 600 will be described herein with reference to the seed-planting implement 10 and the system 200 described above with reference to FIGS. 1-7. However, it should be appreciated by those of ordinary skill in the art that the disclosed method 600 may generally be implemented with any agricultural implement having any suitable implement configuration and/or within any system having any suitable system configuration. In addition, although FIG. 8 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 8, at (602), the method 600 may include receiving, with a computing system, non-contact-based sensor data indicative of subsurface soil of soil of a field. For instance, as described above, the computing system 210 may receive data from the non-contact-based sensor(s) 114 of the seed-planting implement 10 as the seed-planting implement 10 travels across a field to perform a seed planting operation. Such non-contact-based sensor data may, in turn, be indicative of the subsurface soil 302.

Additionally, at (604), the method 600 may include determining, with the computing system, a property of the subsurface soil based on the received non-contact-based sensor data. For instance, as described above, the computing system 210 may be configured to determine the property(ies) of the subsurface soil 302 based on the received non-contact-based sensor data.

Moreover, as shown in FIG. 8, at (606), the method 600 may include determining, with the computing system, when an air pocket is present between a seed planted within the subsurface soil and the subsurface soil based on the determined property of the subsurface soil. For instance, as described above, the computing system 210 may be configured determine when the air pocket(s) 310 is present between seeds planted within the subsurface soil 302 and the subsurface soil 302 based on the determined property(ies) of the subsurface soil 302.

Furthermore, at (608), the method 600 may include initiating, with the computing system, a control action associated with adjusting a force applied to the ground-engaging tool when determined that the air pocket is present. For instance, as described above, the computing system 210 may be configured to initiate a control action associated with adjusting the force applied to the ground-engaging tool(s), such as the press wheel(s) 54 and/or the closing disk(s) 48, when determined that the air pocket(s) 310 is present.

It is to be understood that the steps of the control logic 400, the control logic 500, and the method 600 are performed by the computing system 210 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 210 described herein, such as the control logic 400, the control logic 500, and the method 600, is implemented in software code or instructions which are tangibly stored on a tangible computer readable medium. The computing system 210 loads the software code or instructions via a direct interface with the computer readable medium or via a wired and/or wireless network. Upon loading and executing such software code or instructions by the computing system 210, the computing system 210 may perform any of the functionality of the computing system 210 described herein, including any steps of the control logic 400, the control logic 500, and the method 600 described herein.

The term "software code" or "code" used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term "software code" or "code" also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A seed-planting implement, comprising:
a row unit frame;
a ground-engaging tool supported by the row unit frame, the ground-engaging tool configured to engage soil of the field during a seed planting operation;
a non-contact-based sensor configured to capture data indicative of subsurface soil of the soil; and
a computing system communicatively coupled to the non-contact-based sensor, the computing system configured to:
determine a property of the subsurface soil based on the data captured by the non-contact-based sensor;
determine when an air pocket is present between a seed planted within the subsurface soil and the subsurface soil based on the determined property of the subsurface soil; and
when determined that the air pocket is present, initiate a control action associated with adjusting a force applied to the ground-engaging tool.

2. The seed-planting implement of claim 1, wherein the non-contact-based sensor comprises a low induction number (LIN) sensing device.

3. The seed-planting implement of claim 1, wherein the ground-engaging tool comprises a press wheel or a closing disk.

4. A system for detecting air pockets within a field, the system comprising:
a ground-engaging tool configured to engage soil of the field during a seed planting operation;
a non-contact-based sensor configured to capture data indicative of subsurface soil of the soil; and
a computing system communicatively coupled to the non-contact-based sensor, the computing system configured to:
determine a property of the subsurface soil based on the data captured by the non-contact-based sensor; and
determine when an air pocket is present between a seed planted within the subsurface soil and the subsurface soil based on the determined property of the subsurface soil.

5. The system of claim 4, wherein, when determining when the air pocket is present, the computing system is configured to:
compare the determined property of the subsurface soil to a predetermined property value range; and
determine that the air pocket is present when the determined property of the subsurface soil falls within the predetermined property value range.

6. The system of claim 4, wherein, when determining the property of the subsurface soil, the computing system is configured to:
determine a relative permittivity value of the subsurface soil based on the data captured by the non-contact-based sensor.

7. The system of claim 4, wherein, when determining the property of the subsurface soil, the computing system is configured to:
determine an electrical conductivity value of the subsurface soil based on the data captured by the non-contact-based sensor.

8. The system of claim 4, wherein the computing system is further configured to:
initiate a control action associated with adjusting a force applied to the ground-engaging tool when determined that the air pocket is present.

9. The system of claim 4, wherein the ground-engaging tool comprises a press wheel or a closing disk.

10. The system of claim 4, wherein the computing system is further configured to:
generate a representation of a portion of soil within the field based on the data captured by the non-contact-based sensor; and
determine the property of the subsurface soil based on the generated representation.

11. The system of claim 4, wherein the non-contact-based sensor comprises a low induction number (LIN) sensing device.

12. The system of claim 4, wherein the computing system is further configured to:
generate a field map identifying one or more locations within the field at which it is determined that the air pocket is present.

13. The system of claim 4, wherein the non-contact-based sensor is installed on a seed-planting implement configured to perform a seed planting operation on the field.

14. A method for detecting air pockets within a field as a seed-planting implement travels across the field, the seed-planting implement including a ground-engaging tool configured to engage soil of the field during a seed planting operation, method comprising:
receiving, with a computing system, non-contact-based sensor data indicative of subsurface soil of the soil;
determining, with the computing system, a property of the subsurface soil based on the received non-contact-based sensor data;
determining, with the computing system, when an air pocket is present between a seed planted within the subsurface soil and the subsurface soil based on the determined property of the subsurface soil; and
initiating, with the computing system, a control action associated with adjusting a force applied to the ground-engaging tool when determined that the air pocket is present.

15. The method of claim 14, further comprising:
comparing, with the computing system, the determined property of the subsurface soil to a predetermined property value range; and
determining, with the computing system, that the air pocket is present when the determined property of the subsurface soil falls within the predetermined property value range.

16. The method of claim 14, wherein determining the property of the subsurface soil comprises:
determining, with the computing system, a relative permittivity value of the subsurface soil based on the received non-contact-based sensor data.

17. The method of claim 14, wherein determining the property of the subsurface soil comprises:
determining, with the computing system, an electrical conductivity value of the subsurface soil based on the received non-contact-based sensor data.

18. The method of claim 14, further comprising:
generating, with the computing system, a representation of a portion of soil within the field based on the received non-contact-based sensor data; and
determining, with the computing system, the property of the subsurface soil based on the generated representation.

19. The method of claim 14, further comprising:
generating, with the computing system, a field map identifying one or more locations within the field at which it is determined that the air pocket is present.

20. The method of claim 14, wherein the non-contact-based sensor comprises a ground-penetrating radar (GPR) sensing device.
